(19) United States
(12) Patent Application Publication
(10) Pub. No.: US 2026/0280135 A1
(43) Pub. Date: Sep. 17, 2026

(54) DIELECTRIC ROD ANTENNA AND DIELECTRIC ROD

(71) Applicant: DKK Co., Ltd., Chiyoda-ku Tokyo (JP)

(72) Inventors: Keisuke SATO, Chiyoda-ku Tokyo (JP); Ichiro OSHIMA, Chiyoda-ku Tokyo (JP); Hisamatsu NAKANO, Chiyoda-ku Tokyo (JP)

(73) Assignee: DKK Co., Ltd., Chiyoda-ku Tokyo (JP)

(21) Appl. No.: 19/472,884

(22) PCT Filed: Mar. 8, 2024
(86) PCT No.: PCT/JP2024/009038

§ 371 Date: Oct. 6, 2025

(30) Foreign Application Priority Data
Apr. 7, 2023 (JP) 2023-062604

(51) Int. Cl. H01Q 13/24; H01Q 15/08; H01Q 21/08

(52) U.S. Cl. CPC H01Q 13/24; H01Q 15/08; H01Q 21/08

(57) ABSTRACT

[Problem] The purpose of the present invention is to realize a dielectric rod antenna and a dielectric rod that are capable of relatively reducing transmission line loss, increasing gain, and handling beam scanning in an array antenna of a millimeter wave band or above.

[Solution] This dielectric rod is mounted to an external antenna and comprises a plurality of dielectric elements. The dielectric elements are arranged so that one or more dielectric elements correspond to each antenna element included in the external antenna. The dielectric elements each have a base part, a distal-end part, and a body part connecting the base part and the distal-end part. The base parts are arranged in a lattice shape. The body parts each have a shape extending substantially linearly from the base parts toward the distal-end parts. Each of the body parts is arranged so as to mutually separate from the base part toward the distal-end part.

### TECHNICAL FIELD

This invention relates to dielectric rod antennas and dielectric rods, in particular to dielectric rod antennas and dielectric rods used in mobile communication systems and base station antenna systems.

### BACKGROUND ART

In the 5G millimeter wave band, area is secured by scanning a high-gain beam with an array antenna. In Beyond 5G/6G, utilization of high frequencies up to 300 GHz is being considered, which will increase the need for high-gain beam scanning. One of gain-enhancing technology other than array antennas is the dielectric rod antenna, in which a dielectric material is extended in the axial direction.

The millimeter wave band (28 GHz band) has been allocated from 5G. However, the disadvantage is that the loss is large depending on the communication distance.

The link between each terminal and base station is realized by scanning a high-gain beam with an array antenna. This trend becomes more problematic as the frequency increases.

Array antennas are generally composed of 64 elements of 8×8, or 8 rows and 8 columns, or more, and often have a maximum antenna gain of 22 dBi or more.

The transmission lines at the back side of the board are very long, resulting in significant losses, such as losses of 4 dB or more. Therefore, reducing transmission line losses has become an issue. In 6G, where wave of up to 300 GHz is expected to be used, it is concerned that transmission line losses will increase even more.

Patent Literature 1 describes a beamforming device and a beamforming method. Amplifiers and phase shifters are arranged in each element to realize beam scanning.

A mixer is connected to each element, and a long transmission line is designed at an intermediate frequency, i.e., a frequency lower than the frequency of actual wireless communication, thus reducing loss.

Patent literature 2 describes a dielectric rod antenna. In this dielectric rod antenna, the antenna gain is enhanced by extending the dielectric in the direction in which radio waves propagate.

Non-patent document 1 describes a dielectric rod antenna array with dielectric rods for each individual antenna element.

### PRIOR ART

### Patent Literature

[Patent Literature 1] Japan Patent Publication Raid Open No. 2021-16077

[Patent Literature 2] Japan Patent Publication Raid Open No. 2005-347936

[Non-Patent Literature 1] Gabriel L. Saffold et.al, “Dielectric Rod Antenna Array With Planar Folded Slot Antenna Excitation,” IEEE Open Journal of Antennas and Propagation, Volume 2, 2021, page 664-673

### SUMMARY OF THE INVENTION

### Problem to Be Solved by the Invention

The large scale and multiple mixer circuits described in the patent document 1 cause high cost and complexity of wiring design. The structure described in Patent Document 2 does not increase transmission line loss, but beam scanning cannot be realized. In the dielectric rod antenna array described in Non-Patent Document 1, each rod faces in the same direction, and although antenna gain enhancement can be achieved, beam scanning to create a wide-angle area cannot be supported. In addition, the dielectric must be grounded and adjusted individually, which not only increases the cost of manufacturing and assembly, but also requires readjustment of each antenna element on site due to misalignment caused by transportation, making practical application impractical.

Therefore, it is an object of this invention to realize a low-cost dielectric rod antenna and a dielectric rod, which can support relatively low transmission line loss and high gain, as well as beam scanning, in array antennas in the millimeter wave band and above.

Other objects of the invention are also described in the embodiments for carrying out the invention.

### Means for Solving the Problems

The dielectric rod in one example of the present invention is a dielectric rod to be attached to an external antenna, having: a plurality of dielectric elements, the plurality of dielectric elements are arranged such that one or more dielectric elements correspond to each antenna element of the external antenna, the dielectric elements have a base part, a distal end part, and a body part connecting the base part and the distal end part, the base is arranged in a grid pattern, the body part is arranged in a grid pattern, and each body part has a shape extending substantially linearly from the base part to the distal end part, wherein each body part is arranged to be spaced apart from each other from the base part to the distal end part.

The dielectric rod in one example of the present invention is a dielectric rod of the above, wherein the grid pattern is a single row.

The dielectric rod in one example of the present invention is a dielectric rod of any of the above, wherein the grid pattern has m rows and n columns, where m and n are two or more natural numbers.

The dielectric rod in one example of the present invention is a dielectric rod of any of the above, wherein all of the body parts are arranged to be spaced apart from each other in at least one direction, from the base part the distal end part.

The dielectric rod in one example of the present invention is a dielectric rod of any of the above, wherein all of the body parts are arranged to be spaced apart from each other from the base part toward the distal end part.

The dielectric rod in one example of the present invention is a dielectric rod of any of the above, wherein the dielectric constant is less than or equal to 4, and, the length of the dielectric element is 15 wavelengths or longer.

The dielectric rod in one example of the present invention is a dielectric rod of any of the above, wherein the dielectric rod is transparent.

The dielectric rod in one example of the present invention is a dielectric rod of any of the above, wherein the dielectric rod has a fixing part configured to fix the positional relationship with the antenna.

The dielectric rod in one example of the present invention is a dielectric rod of any of the above, wherein the body part tapers from the base part to the distal end part, and that the rate of decrease of the diameter of the dielectric element relative to the length direction of the dielectric element is larger on the base part.

The dielectric rod in one example of the present invention is a dielectric rod of any of the above, wherein the body portion has a smooth curved shape.

The dielectric rod in one example of the present invention is a dielectric rod of any of the above, wherein the thickness of the body part varies in stages and is longer at the distal end part in each stage.

The dielectric rod antenna in one example of the present invention is a dielectric rod antenna provided with the dielectric rod of any of the above, and an antenna unit having a plurality of antenna elements.

The dielectric rod antenna in one example of the present invention is a dielectric rod antenna of any of the above, provided with a transmitter unit configured to transmit radio waves of millimeter waves or higher, or a receiver unit configured to receive radio waves of millimeter waves or higher.

### EFFECT OF THE INVENTION

The present invention, having the above configuration, realizes a novel dielectric rod antenna and a novel dielectric rod that can achieve, for the first point, reduction of losses, and, for the second point, at least equivalent antenna gain, typically up to 22 dBi or more, and for the third point, beam scanning similar to at least equivalent antennas, as compared to conventional antennas.

Other effects of the invention are also described in the embodiments for carrying out the invention.

### BRIEF DESCRIPTION OF THE DRAWINGS

FIG. 1 shows an example of a dielectric rod antenna in one embodiment of the present invention.

FIG. 2 shows example configuration of a dielectric rod antenna in an example of the present invention.

FIG. 3 shows results of the dielectric rod antenna in one example of the present invention.

FIG. 4 shows results in a comparative example.

FIG. 5 shows an example of the configuration of a dielectric rod antenna in an example of the present invention.

FIG. 6 shows an example of the configuration of a dielectric rod antenna in an example of the present invention.

FIG. 7 shows an example configuration of a dielectric rod antenna in an example of the present invention.

FIG. 8 shows an example configuration of a dielectric rod antenna in an example of the present invention.

FIG. 9 shows an example configuration of a dielectric rod antenna in an example of the present invention.

FIG. 10 shows an example configuration of a dielectric rod antenna in an example of the present invention.

FIG. 11 shows an example configuration of a dielectric rod antenna in an example of the present invention.

FIG. 12 shows an example configuration of a dielectric rod antenna in an example of the present invention.

FIG. 13 shows an example configuration of a dielectric rod antenna in an example of the present invention.

### DETAILED DESCRIPTION

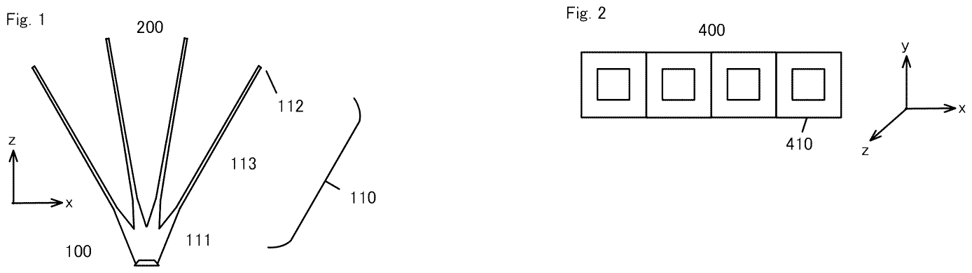

FIG. 1 shows an example of a dielectric rod 100.

The dielectric rod 100 is configured to be attached to an external antenna 400 as shown in FIG. 2.

The excitation source is an array antenna, and the dielectric is designed to provide high gain for multiple beam directions, which is achieved by beamforming or multi-beam circuitry.

The number of elements in the excitation source and the number of beams utilized (number of rod extension directions) can be designed so that each beam can be separated. The beam forming method of the excitation source can be either analog/digital beamforming or multi-beam using Butler matrix, etc.

The dielectric rod 100 in this example has a plurality of dielectric elements 110. The dielectric elements 110 are arranged such that one or more dielectric elements 110 correspond to the respective antenna elements 410 of the external antenna 400. In this example, one or more dielectric elements 110 are arranged to correspond to the respective antenna elements 410.

The dielectric elements 110 have a base part 111, a distal end part 112, and a body part 113 connecting the base part 111 and the distal end part 112.

The base part 111 is arranged in a grid pattern. The term “arranged in a grid pattern” designates that the bases are fixed in position to each other and are arranged without gaps. The lattice can be two-dimensional in longitudinally and sideways, or in a single horizontal row. Of course, they can be arranged in various directions, such as diagonally or vertically, according to the installation configuration of the antenna. In this explanation, a dielectric rod antenna is sometimes simply referred to as an antenna.

The body portion 113 has a shape extending in an abbreviated straight line from the base part 111 to the distal end part 112.

Each of the body portions 113 is arranged to be spaced apart from each other from the base part 111 to the distal end part 112. Here, “each of the body parts 113 are arranged to be spaced apart from each other from the base part 111 toward the distal end part 112” includes the case where they are the same distance from each other. In other words, the distances of the body sections 113 are configured to be the same or apart. However, it does not include the case where all the distances are the same. In other words, at least some of the body sections are arranged such that their distance from each other separates them from each other, so that the body parts as a whole, are arranged such that they are separated from each other from the base part 111 toward the distal end part 112. This configuration enables efficient communication over a wide area.

In one example, as shown in FIG. 1, the configuration can also be such that the respective body sections 113 are all arranged to be spaced apart from each other from the base part 111 toward the distal end part 112 in at least one direction, such as horizontally or vertically. According to this configuration, efficient communication can be achieved over a wider area in accordance with the direction in which the range of transmission and reception is extended.

As shown in FIG. 1, the dielectric can be extended in the beam direction used. With this configuration, higher gain can be achieved, and at the same time, by manufacturing the dielectric rod 100 from low-loss material, the transmission line loss can be extremely small.

Instead of the external antenna 400 in FIG. 2, the excitation source can be an array antenna 300 capable of horizontal and vertical beam scanning, as shown in FIG. 6.

As shown in FIG. 1, the number of antenna elements and the number of beams used are the same. In this example, the number of beams is reduced to four. In particular, it can contribute to the realization of the following beam scanning. That is, for the first point, the maximum direction of each beam can be separated. And for the second point, the overlap of each beam can be designed at an appropriate level.

In the art described in Patent Literature 1, antenna gain was secured by increasing the number of elements, but in this example, the use of dielectric rod 100 enables gain increase without increasing the number of elements. Furthermore, a reduction in transmission line loss can be achieved at the same time. In addition, the dielectric rod 100 can achieve high gain for beams with different directions.

In the art described in Patent Literature 2, only one excitation amplifier can be connected to one waveguide antenna. This configuration makes it essential to have thermal countermeasures or other measures, since the power is concentrated in one antenna. In addition, a high power amplifier cannot be designed for higher frequencies. Therefore, it is desirable to increase the output by parallel synthesis.

In contrast, in the dielectric rod antenna 200 using the dielectric rod 100, the amplifier can be connected to each element because the excitation source is an array antenna. In the example shown in the figure, since four amplifiers can be connected, the output can be increased by 6 dB. Thus, this configuration is suitable for antennas above millimeter wave, where it is difficult to secure the output with amplifiers alone. Unlike the dielectric rod antenna array described in Non-Patent Literature 1, it is not necessary to individually ground and adjust the dielectric, which not only reduces manufacturing and assembly costs, but also enables a one-time adjustment to accommodate misalignment caused by transportation. In other words, it is low-cost and easy to install.

In this example, the 100 dielectric rods have a single row of grids. Combining this with an array antenna results in a four-way horizontal dielectric rod antenna 200. Of course, the grid may be two-dimensional in shape other than a single row.

As described above, by reducing the number of elements in the array antenna 300 of the excitation source, the transmission line is shortened and relatively low loss is achieved compared to the conventional system. In addition, by providing a dielectric designed in a manner that matches the number of elements and the number of beams utilized, an antenna with low loss, high gain, and beam scanning can all be realized. As an additional effect, since the excitation source is an array antenna, an amplifier can be connected to each element to increase the power by parallel synthesis.

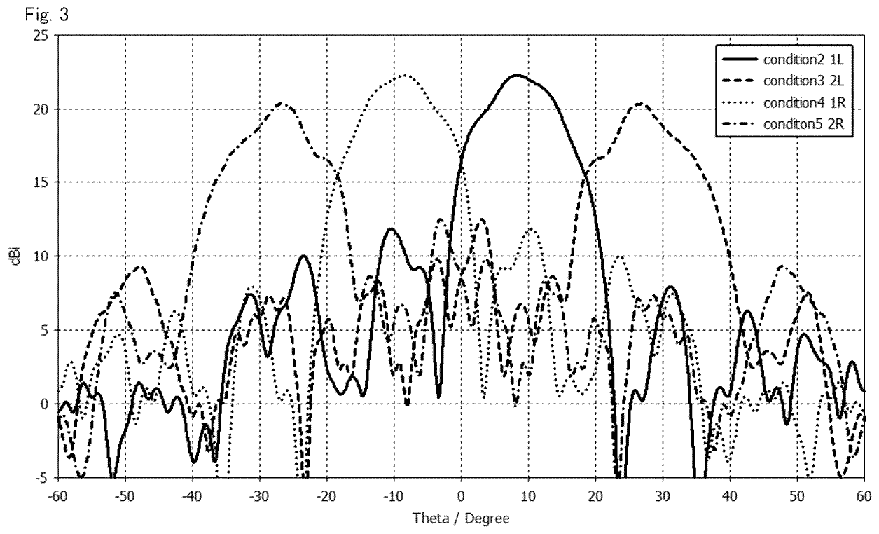

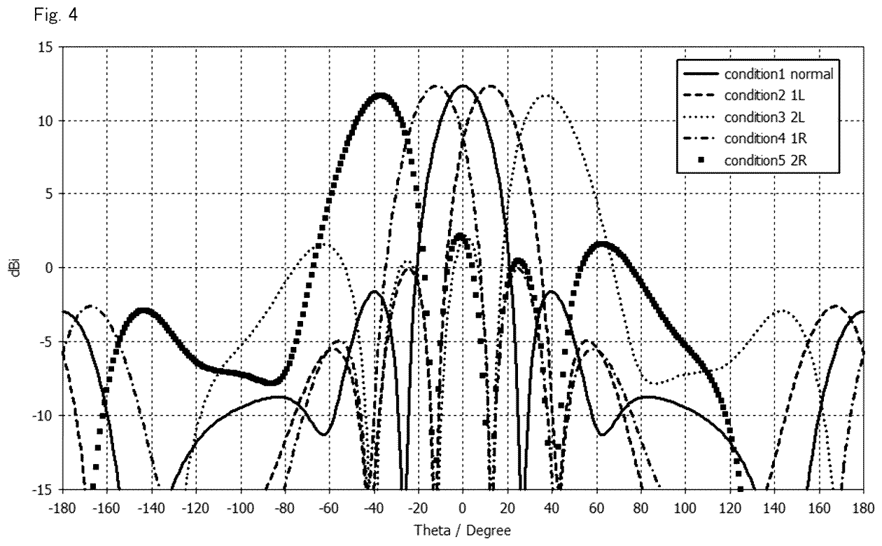

FIG. 3 shows an example of the results of a dielectric rod antenna 200 using dielectric rod 100 in the present invention, and FIG. 4 shows an example of the results of an excitation source antenna only. The horizontal axis represents the direction angle and the vertical axis represents the output.

As shown in FIG. 3, compared to the case with excitation source antennas only, favorable high gain multi-beam/beamforming performance is obtained by reducing the number of antennas to be equal to the number of beams.

Specifically, each of the unit antennas 301 is in the maximum direction where the output of each of the unit antennas 301 is at its maximum, while satisfying the other conditions, that is, the output is separated from any one of other unit antennas by 10 dB or more. To be specific, the maximum gain of 20.3 dBi or more is achieved, with the gain of 20.3 dBi at 27 degrees left and right, and gain of 22.3 dBi at 8 degrees left and right. On the other hand, overlapping of beams can be achieved at the gain of 15 dBi or more at the left and right 18 degrees and 0 degrees.

In other words, a maximum gain of 22 dBi or more can be obtained in this example. Furthermore, in the maximum direction, there is a difference of more than 10 dB from the other beam of the other conditions. In other words, beam separate with 10 dB or more can be achieved. In addition, overlapping of beams with gain of 15 dBi or more is achieved. In contrast, such gain and overlapping cannot be ensured with an antenna that has only an excitation source antenna and no dielectric rod 100, as shown in FIG. 4. Thus, compared to the case without the dielectric rod 100, a gain enhancement of about 10 dB from 12.3 dBi to 22.1 dBi is possible with the dielectric rod 100.

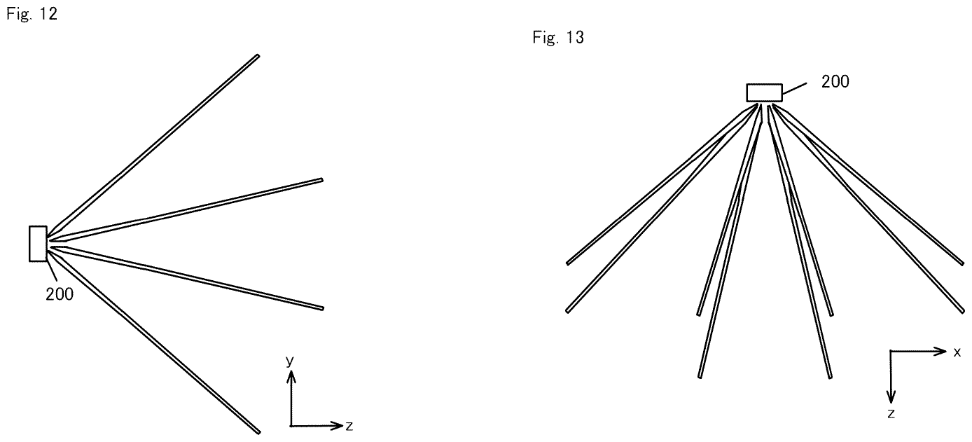

FIG. 5 shows an example of the dielectric rod 100 in one example of the invention. FIGS. 12 and 13 also show side views.

The grid pattern has m rows and n columns, where m and n are natural numbers greater than or equal to 2. The arrangement can be in any direction, such as horizontal, vertical, or diagonal for the rows.

In this example, the antenna is combined with the array antenna shown in FIG. 6 to form a vertical 4-way horizontal 4-way dielectric rod antenna 200.

In this way, the number of rods can be changed to match the number of elements, contributing to higher gain for any number of beams.

In one example, as shown in FIGS. 5, 12, and 13, all of the respective body sections 113 can be configured to be arranged so that they are spaced apart from each other from the base part 111 to the distal end part 112. According to this configuration, a wider range of efficient communication can be achieved for both horizontal and vertical directions, for example.

In one example, the dielectric rod 100 has a dielectric constant of 4 or less and the length of the dielectric element 110 is 15 wavelengths or longer. Here, the wavelength is the wavelength of radio waves transmitted or received using the dielectric rod 100, i.e., the wavelength of radio waves transmitted or received by the array antenna.

This configuration enables efficient transmission and reception of radio waves by the antenna.

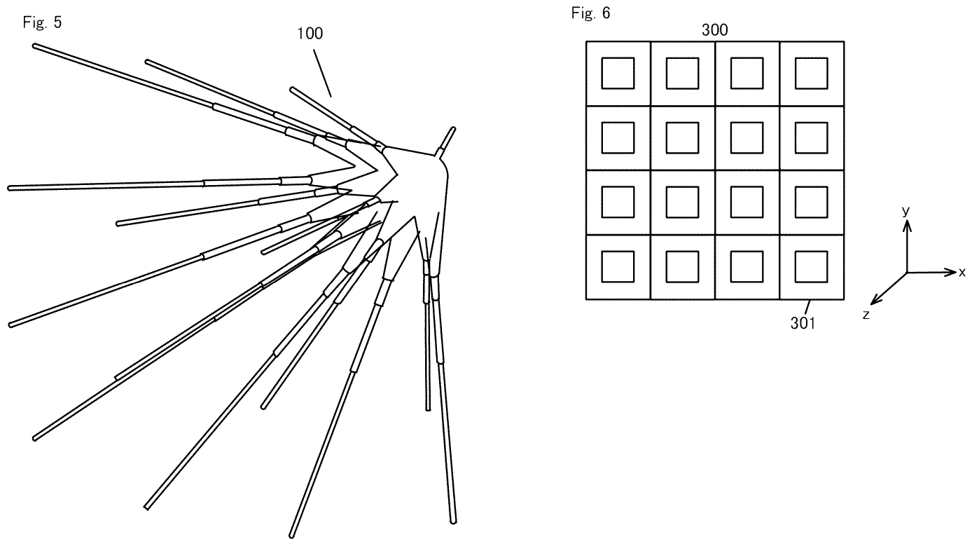

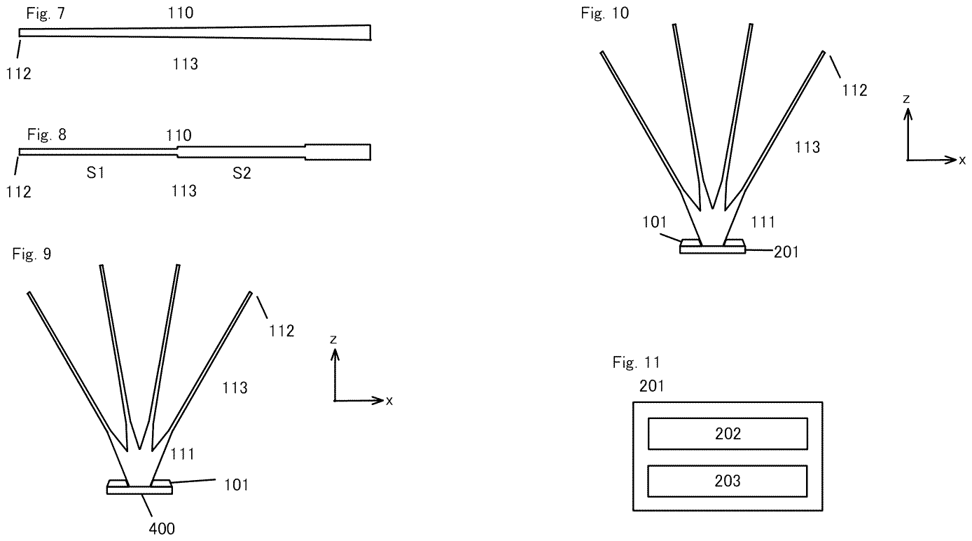

FIG. 7 shows an example of a dielectric element 110 with a dielectric rod 100 in one example of the invention.

The body part 113 tapers from the base part 111 to the distal end part 112 and has a shape in which the rate of decrease of the diameter of the dielectric element relative to the length direction of the dielectric element is larger on the base side. In other words, the configuration of the body part is a shape in which the diameter is greatly reduced at the base side from a relative viewpoint. Here, “the shape in which the body part 113 tapers from the base part 111 to the distal end part 112” designates a shape in which the body part 113 is thinner at the portion connected to the distal end part 112 than at the portion connected to the base part 111, even if there are portions of the body portion 113 whose thickness is approximately the same.

In this example, the body 113 has a smooth curved shape. in other words, the shape of the rod has a curvilinear taper.

Although high gain can be achieved with a linear taper or a simple cylindrical shape, a higher gain characteristic can be obtained by adopting the shape as shown in the figure.

With the dielectric corresponding to each direction of the antenna element, i.e., the rod, as shown in the figure, it is possible to achieve high gain and beam forming at the same time.

FIG. 8 shows an example of a dielectric element 110 with a dielectric rod 100 in one example of the invention.

Concerning the configuration of the dielectric, the thickness of the body part 113 varies in stages. However, in addition to being thinner toward the distal end part, it is desirable that the staircase becomes longer towards the distal end part in each staircase. In other words, it is desirable that the thickness of the body part varies in stages of varying length, and the length is longer toward the distal end part in each stage. In the example, the staircase (step) S1 at the distal end part side is longer than the staircase (step) S2 at the base part side.

Specifically speaking, after designing the curvilinear taper, a step approximation is made based on this taper. Since the thickness changes in stages, fabrication can be simplified.

In one example of the invention, the dielectric rod 100 is transparent.

This configuration allows light to penetrate the dielectric rod 100, which is placed in front of the dielectric rod antenna 200, so that the state of the antenna elements and other components can be checked. In addition, the configuration can be made to have an excellent appearance.

FIG. 9 shows an example of dielectric rod 100 in one example of the invention.

The dielectric rod 100 has a fixing part 101 that fixes the positional relationship with an external antenna 400.

The fixing part 101 may attach the dielectric rod 100 directly to the antenna, or it may attach the dielectric rod 100 to other parts such as a wall surface, as long as the positional relationship between the dielectric rod 100 and the antenna can be fixed.

This configuration allows the dielectric rod 100 to be easily fixed to the antenna.

FIG. 10 shows an example of a dielectric rod antenna 200.

The dielectric rod antenna 200 has any one of the dielectric rods 100 described above and an antenna unit 201 having a plurality of antenna elements. The plurality of antenna elements are, for example, of the same configuration as in FIG. 2.

FIG. 11 shows an example configuration of the antenna unit 201 of the dielectric rod antenna 200 in one example.

In the dielectric rod antenna 200, the antenna unit 201 has a transmitter unit 202 that transmits radio waves of frequencies in the quasi-millimeter wave band or higher frequency waves, or a receiver unit 203 that receives radio waves in the quasi-millimeter wave band or higher frequency waves. Frequencies above the quasi-millimeter-wave band here designates frequencies of 20 GHz or above.

Having the above configuration, the present invention realizes a novel dielectric rod antenna 200 and dielectric rod 100, which achieve, for the first point, reduction of the antenna losses, for the second point, achieve, at least equivalent antenna gain, i.e., typically up to 22 dBi or more, and for the third point, at least the same beam scanning as an equivalent antenna, as compared to conventional antennas,

It goes without saying that the invention is not limited to the above examples, but includes various examples to the extent that they do not depart from the intent of the invention.

For example, with respect to the array arrangement of the excitation source, the present invention is applicable not only to linear and square arrays, but also to other arrangement methods such as triangular arrays.

### EXPLANATION OF REFERENCE NUMERALS

100 dielectric rod
110 dielectric element
111 base part
112 distal end part
113 body part
101 fixing part
200 dielectric rod antenna
201 antenna unit
202 transmitter unit
203 receiver unit
300 array antenna
301 unit antenna
400 external antenna
410 antenna element

1. A dielectric rod to be attached to an external antenna, comprising:
a plurality of dielectric elements,
the plurality of dielectric elements are arranged such that one or more dielectric elements correspond to each antenna element of the external antenna,
the dielectric elements have a base part, a distal end par, and a body part connecting the base part and the distal end part,
the base is arranged in a grid pattern,
the body part is arranged in a grid pattern, and
each body part has a shape extending substantially linearly from the base part to the distal end part, wherein
each body part is arranged to be spaced apart from each other from the base part to the distal end part, wherein
the dielectric constant is less than or equal to 4, and,
the length of the dielectric element is 15 wavelengths or longer.

2. A dielectric rod according to claim 1, wherein the grid pattern is a single row.

3. A dielectric rod according to claim 1, wherein the grid pattern has m rows and n columns, where m and n are two or more natural numbers.

4. A dielectric rod according to claim 3, wherein all of the body parts are arranged to be spaced apart from each other in at least one direction, from the base part the distal end part.

5. A dielectric rod according to claim 3, wherein all of the body parts are arranged to be spaced apart from each other from the base part toward the distal end part.

6-13. (canceled)

14. A dielectric rod according to claim 1, wherein the dielectric rod is transparent.

15. A dielectric rod as claimed in claim 1, wherein the dielectric rod has a fixing part configured to fix the positional relationship with the antenna.

16. A dielectric rod as claimed in claim 1, wherein the body part tapers from the base part to the distal end part, and that the rate of decrease of the diameter of the dielectric element relative to the length direction of the dielectric element is larger on the base part.

17. A dielectric rod according to claim 14, wherein the body portion has a smooth curved shape.

18. A dielectric rod according to claim 1, wherein the thickness of the body part varies in stages of varying length, and the length is longer toward the distal end part in each stage.

19. A dielectric rod antenna provided with
the dielectric rod according to claim 1, and
an antenna unit having a plurality of antenna elements.

20. A dielectric rod antenna as claimed in claim 19, provided with a transmitter unit configured to transmit radio waves of millimeter waves or higher, or a receiver unit configured to receive radio waves of millimeter waves or higher.
